(19) United States
(12) Patent Application Publication
(10) Pub. No.: US 2020/0032144 A1
(43) Pub. Date: Jan. 30, 2020

(54) LIQUID CRYSTAL COMPOSITION AND LIQUID CRYSTAL DISPLAY COMPONENT

(71) Applicant: SHIJIAZHUANG CHENGZHI YONGHUA DISPLAY MATERIAL CO., LTD., Shijiazhuang City (CN)

(72) Inventors: Jinsong MENG, Shijiazhuang City (CN); Ming LI, Shijiazhuang City (CN); Xing ZHANG, Shijiazhuang City (CN); Guoliang YUN, Shijiazhuang City (CN); Lei ZHAO, Shijiazhuang City (CN); Wei ZHANG, Shijiazhuang City (CN)

(73) Assignee: SHIJIAZHUANG CHENGZHI YONGHUA DISPLAY MATERIAL CO., LTD., Shijiazhuang City (CN)

(21) Appl. No.: 16/220,304

(22) Filed: Dec. 14, 2018

(30) Foreign Application Priority Data
Jul. 24, 2018 (CN) 201810821018.6

(51) Int. Cl. C09K 19/44; C09K 19/34; C09K 19/12; C09K 19/20; C09K 19/32; C09K 19/30

(52) U.S. Cl. CPC C09K 19/44; C09K 2019/3036; C09K 19/12; C09K 19/20; C09K 19/32; C09K 19/3003; C09K 19/3028; C09K 2019/3004; C09K 2019/3009; C09K 2019/122; C09K 2019/301; C09K 2019/3016; C09K 2019/123; C09K 2019/3019; C09K 2019/3025; C09K 2019/3422; C09K 19/3402

(57) ABSTRACT

Disclosed are a liquid crystal composition and a liquid crystal display component. The liquid crystal composition comprises one or more compounds as represented by structural formula I-1 and/or one or more compounds as represented by structural formula I-2, one or more compounds as represented by structural formula II, and one or more compounds as represented by structural formula III:

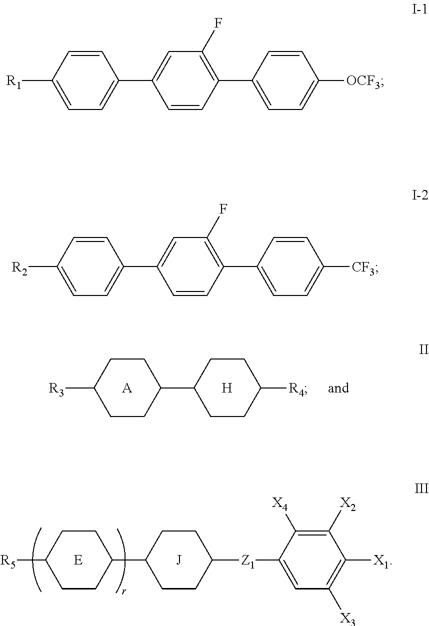

The liquid crystal display component includes the liquid crystal composition. The liquid crystal composition has a lower viscosity, can achieve a fast response, and further has a moderate dielectric anisotropy Δε, a moderate optical anisotropy Δn, and a high stability to heat and light. The liquid crystal display component including the liquid crystal composition has the characteristics of a broader nematic phase temperature range, a suitable birefringence anisotropy, a very high electrical resistivity, a good anti-ultraviolet property, a high charge retention ratio, and a fast response.

### TECHNICAL FIELD

The present invention relates to the technical field of liquid crystal displays. More specifically, the present invention relates to a liquid crystal composition and a liquid crystal display component.

### BACKGROUND ART

At present, the expansion of application range of liquid crystal compounds becomes larger and larger, and the liquid crystal compounds can be used in various types of displays, electro-optical devices, sensors, etc. There are a great variety of liquid crystal compounds used in the above-mentioned display field, wherein nematic liquid crystals are the most widely used. Nematic phase liquid crystals have been used in passive TN and STN matrix displays and systems having a TFT active matrix.

With regard to the application field of thin film transistor techniques (TFT-LCD), although the market in recent years has become very huge, and the techniques also become gradually mature, requirements of display techniques are increasing continuously, especially in terms of achieving a fast response, reducing the drive voltage for reducing power consumption, etc. Liquid crystal materials as one of important optoelectronic materials for liquid crystal displays play an important role in improving the performance of liquid crystal displays.

As liquid crystal materials, they need to have good chemical and thermal stability and stability to electric fields and electromagnetic radiations. Moreover, as liquid crystal materials used for thin film transistor techniques (TFT-LCD), they not only need to have the stabilities as mentioned above, but also should have properties, such as a broader nematic phase temperature range, a suitable birefringence anisotropy, a very high electrical resistivity, a good anti-ultraviolet property, a high charge retention ratio, a low vapour pressure, etc.

As for dynamic picture display applications, the liquid crystal is required to have a very fast response speed in order to eliminate ghosting and trailing of display pictures, and therefore the liquid crystal is required to have a lower rotary viscosity γ₁; in addition, as for portable devices, in order to reduce the energy consumption of equipment, the drive voltage for the liquid crystal is desired to be as low as possible; and as for displays for use in televisions, etc., the requirements for the drive voltage for the liquid crystal are not as low as that.

Therefore, the present invention provides a liquid crystal composition and a liquid crystal display component, to at least solve one of the above-mentioned problems.

### SUMMARY OF THE INVENTION

An object of the present invention is to provide a liquid crystal composition. The liquid crystal composition has a short response time, a lower rotary viscosity γ₁, a higher clearing point, and a better low-temperature intersolubility.

Another object of the present invention is to provide a liquid crystal display component comprising the liquid crystal composition. The liquid crystal display component has the characteristics of a broader nematic phase temperature range, a suitable birefringence anisotropy, a very high electrical resistivity, a good anti-ultraviolet property, a high charge retention ratio, and a fast response.

In order to achieve the above-mentioned first object, the following technical solution is used in the present invention:

a liquid crystal composition comprising one or more compounds as represented by structural formula I-1 and/or one or more compounds as represented by structural formula I-2, one or more compounds as represented by structural formula II, and one or more compounds as represented by structural formula III:

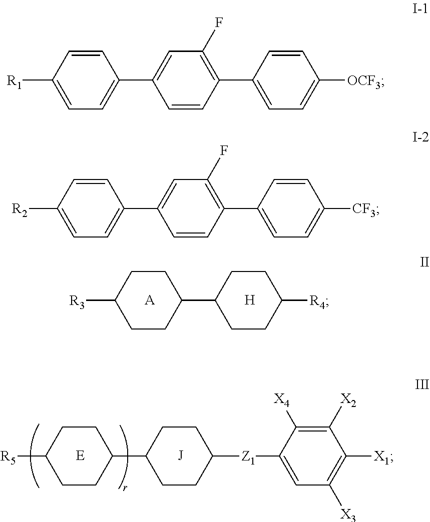

wherein

R₁, R₂, R₃ and R₅ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more non-connected CH₂ in the groups represented by R₁, R₂, R₃ and R₅ may be each independently substituted with cyclopentyl, cyclobutyl, cyclopropyl or oxygen;

R₄ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more non-connected CH₂ in the groups represented by R₄ may be substituted with cyclopentyl, cyclobutyl or cyclopropyl;

Z₁ represents a single bond, —CH₂CH₂—, —CH₂O—, or —CF₂O—;

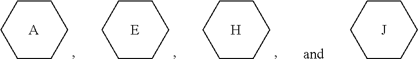

each independently represent

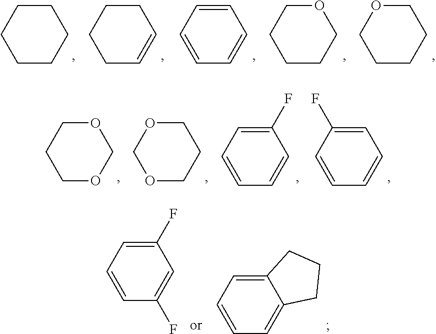

X₁ represents F, fluoroalkyl, fluoroalkoxy, fluoroalkenyl or fluoroalkenyloxy;

X₂, X₃ and X₄ each independently represent H, F, fluoroalkyl, fluoroalkoxy, fluoroalkenyl, fluoroalkenyloxy, or methyl;

r represents 0, 1 or 2; and where r represents 1, Z₁ represents a single bond, X₂, X₃ and X₄ all represent H,

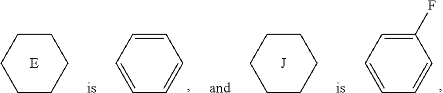

X₁ cannot be OCF₃ or CF₃.

In the present invention, the above-mentioned liquid crystal composition comprises one or more compounds as represented by structural formula I-1, one or more compounds as represented by structural formula II, and one or more compounds as represented by structural formula III; or comprising one or more compounds as represented by structural formula I-2, one or more compounds as represented by structural formula II, and one or more compounds as represented by structural formula III; or comprising one or more compounds as represented by structural formula I-1, one or more compounds as represented by structural formula I-2, one or more compounds as represented by structural formula II, and one or more compounds as represented by structural formula III.

In the present invention, compared with liquid crystal compounds having a similar terphenyl structure, the compound represented by formula I-1 and the compound represented by formula I-2 have a lower rotary viscosity and can improve the response speed of the liquid crystal composition; the compound represented by formula II as a diluent in the liquid crystal composition can reduce the rotary viscosity of the liquid crystal composition and improve the response speed thereof; and the compound represented by formula III is dielectrically positive anisotropic, and by adjusting the content in mass percentage of the compound represented by formula III, the drive voltage of the liquid crystal composition is adjusted.

Preferably, in said liquid crystal composition, the content in mass percentage of the compound as represented by structural formula I-1 and/or the compound as represented by formula I-2 is preferably 1-25%, further preferably 5-15%; the content in mass percentage of the compound as represented by structural formula II is preferably 10-70%, further preferably 20-60%; and the content in mass percentage of the compound as represented by structural formula III is 1-60%, preferably 20-50%.

Preferably, the structural formula of the compounds as represented by structural formula II is specifically one or more selected from formulas II-1 to II-13 below:

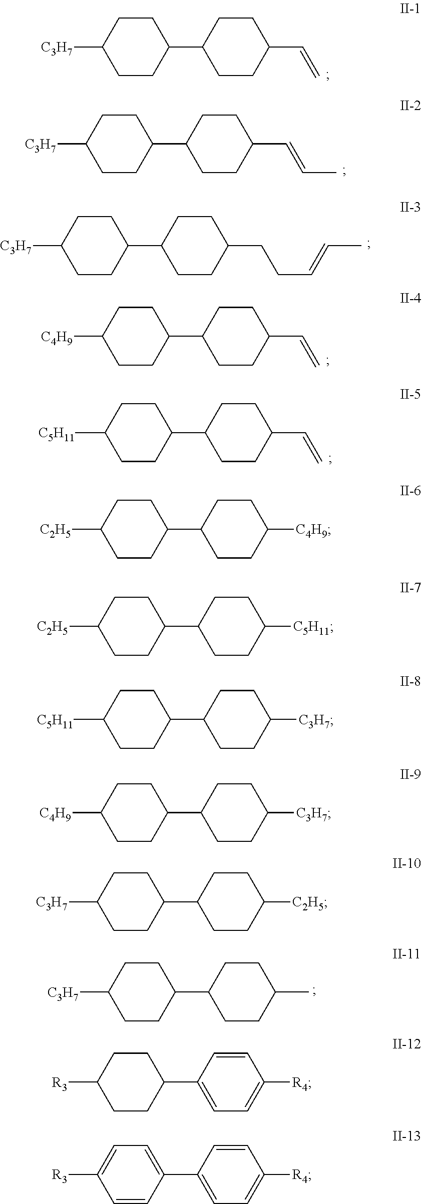

wherein

R₃ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more non-connected CH₂ in the groups represented by R₃ may be substituted with cyclopentyl, cyclobutyl, cyclopropyl or oxygen; and

R₄ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more non-connected CH₂ in the groups represented by R₄ may be substituted with cyclopentyl, cyclobutyl or cyclopropyl.

Preferably, the structural formula of the compounds as represented by structural formula III is specifically one or more selected from formulas III-1 to III-47 below:

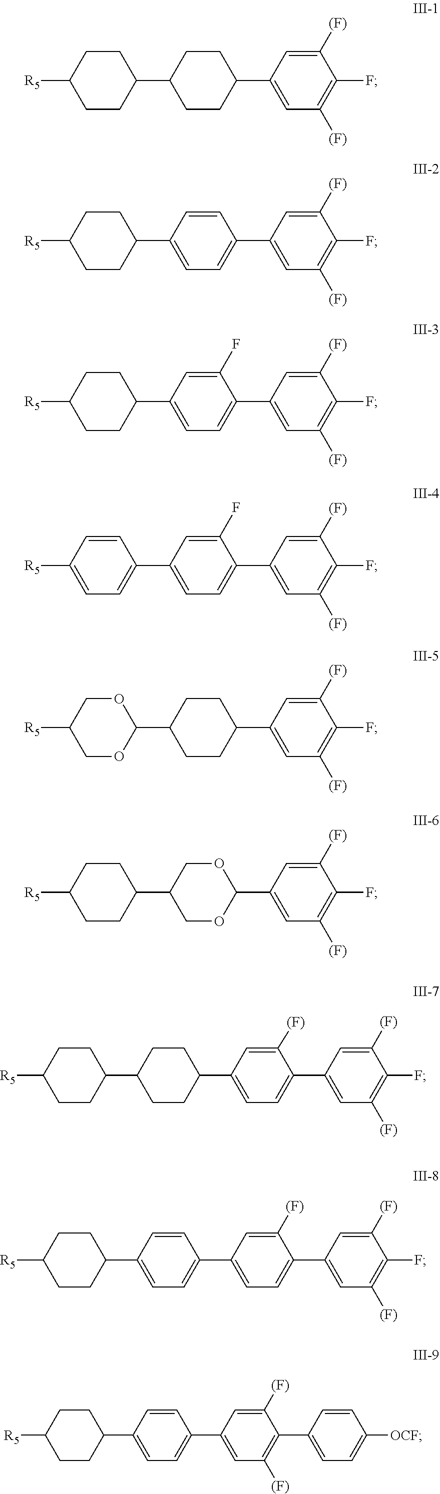

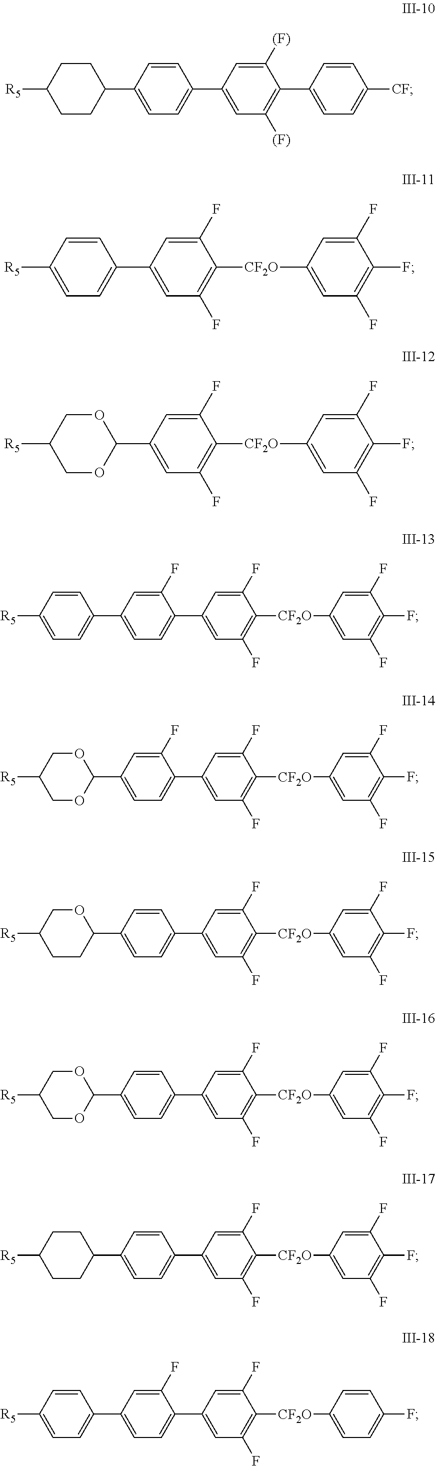

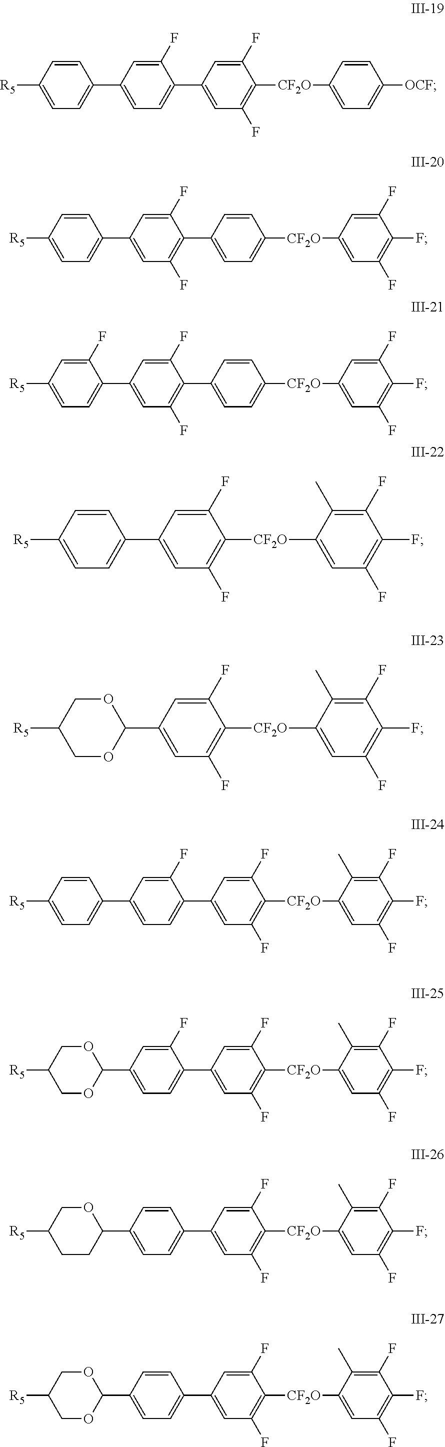

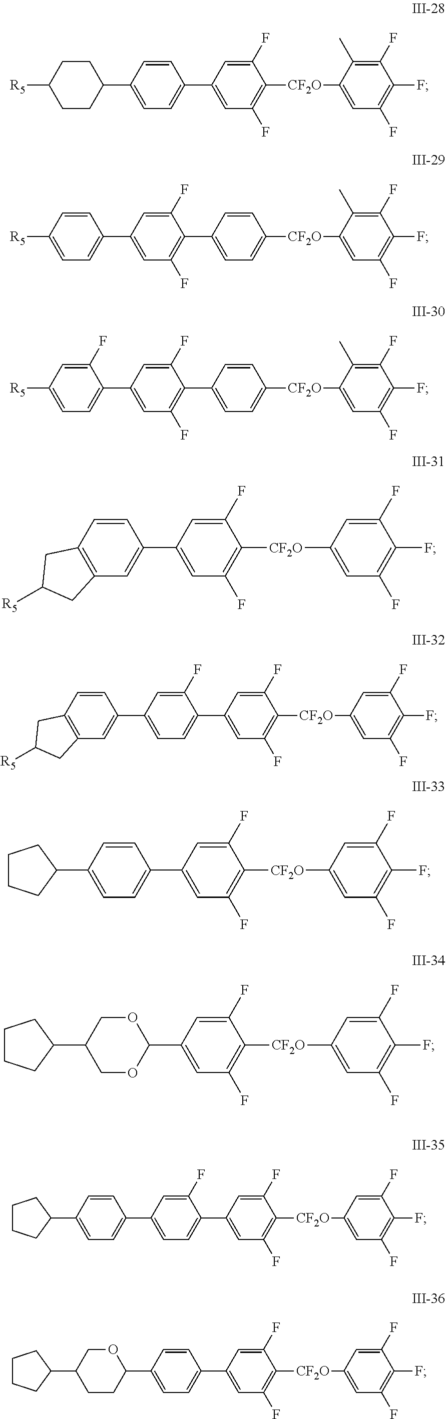

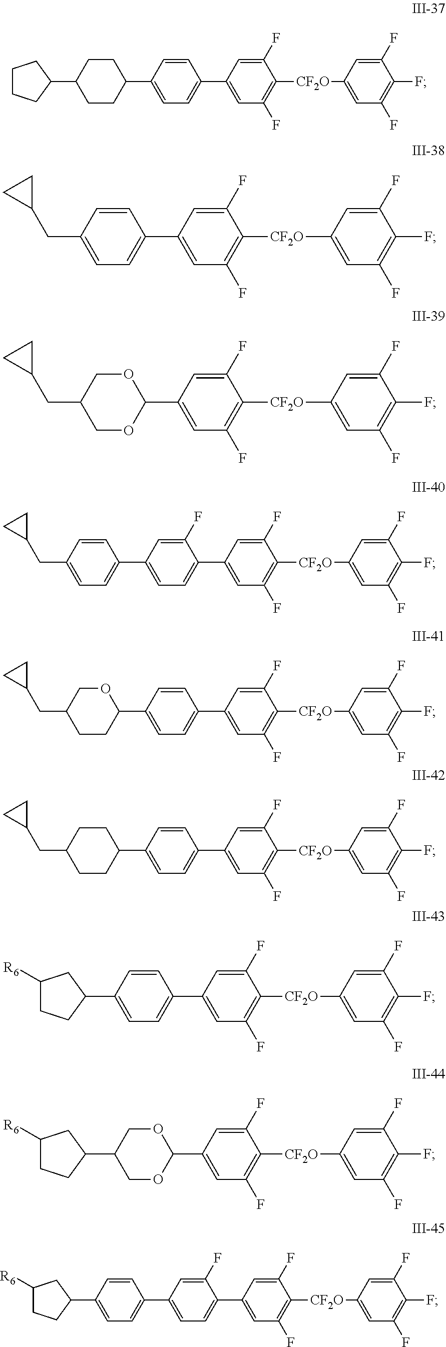

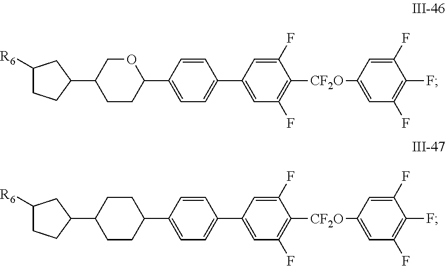

wherein R₅ and R₆ each independently represent an alkyl group having a carbon atom number of 1-5, a fluoro-substituted alkyl group having a carbon atom number of 1-5, an alkoxy group having a carbon atom number of 1-5, a fluoro-substituted alkoxy group having a carbon atom number of 1-5, an alkenyl group having a carbon atom number of 2-5, a fluoro-substituted alkenyl group having a carbon atom number of 2-5, an alkenoxy group having a carbon atom number of 3-5 or an fluoro-substituted alkenoxy group having a carbon atom number of 3-5; and

(F) represents F or H.

Preferably, said liquid crystal composition is a dielectrically positive anisotropic liquid crystal composition, and further comprises one or more compounds represented by formula IV:

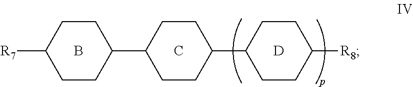

wherein R₇ and R₈ represent an alkyl group having a carbon atom number of 1-10, an alkoxy group having a carbon atom number of 1-10, an alkenyl group having a carbon atom number of 2-10 or an alkenoxy group having a carbon atom number of 3-8, wherein any one or more CH₂ in the groups represented by R₇ and R₈ may be each independently substituted with cyclopentyl, cyclobutyl or cyclopropyl;

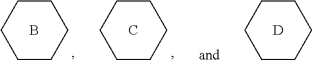

each independently represent

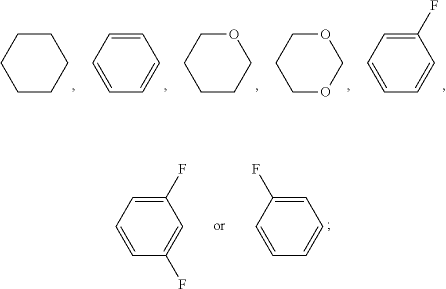

and P represents 1 or 2.

In the present invention, the compound represented by formula IV has a low viscosity, a high clearing point, a large elastic constant, and a dielectric anisotropy close to zero, is a neutral compound, and can improve the clearing point of a liquid crystal composition when used in the liquid crystal composition.

Preferably, in said liquid crystal composition, the content in mass percentage of the compound as represented by structural formula IV is preferably 1-40%, preferably 5-20%.

Preferably, the structural formula of the compound as represented by structural formula IV is specifically one selected from formulas IV-1 to IV-6 below:

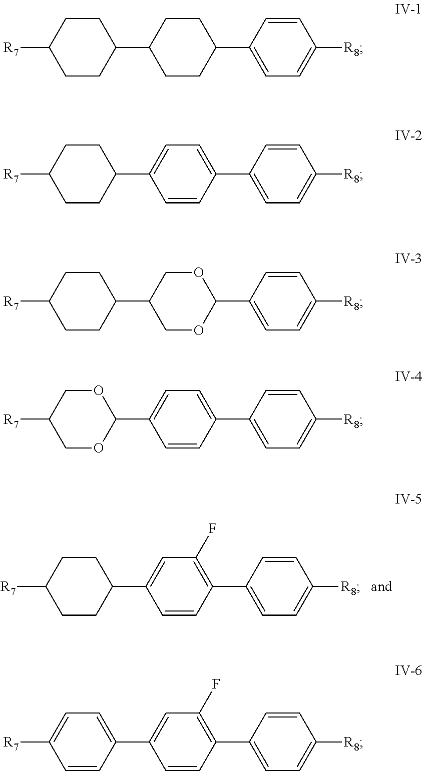

wherein R₇ and R₈ represent an alkyl group having a carbon atom number of 1-5, an alkoxy group having a carbon atom number of 1-5, an alkenyl group having a carbon atom number of 2-5, or an alkenoxy group having a carbon atom number of 3-8, wherein any one or more CH₂ in the groups represented by R₇ and R₈ may be each independently substituted with cyclopentyl, cyclobutyl or cyclopropyl.

Preferably, said liquid crystal composition is a dielectrically positive anisotropic liquid crystal composition, and further comprises one or more compounds represented by formula V:

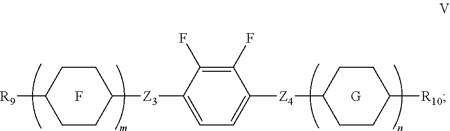

wherein R₉ and R₁₀ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₉ and R₁₀ may be each independently substituted with cyclopentyl, cyclobutyl or cyclopropyl;

Z₃ and Z₄ each independently represent a single bond, —CH₂CH₂— or —CH₂O—;

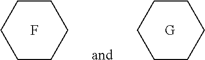

each independently represent

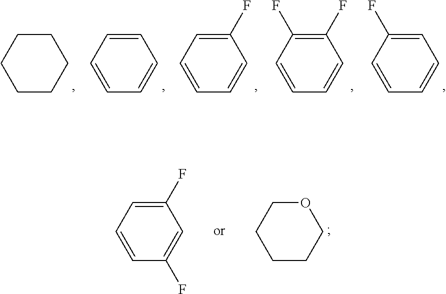

m represents 1 or 2; and n represents 0, 1 or 2.

In the present invention, the compound represented by formula V has a large vertical dielectric constant and can improve the transmittance of the liquid crystal composition.

Preferably, in said liquid crystal composition, the content in mass percentage of the compound as represented by structural formula V is 1-20%, preferably 5-15%.

Preferably, the structural formula of the compound as represented by structural formula V is specifically one selected from formulas V-1 to V-11 below:

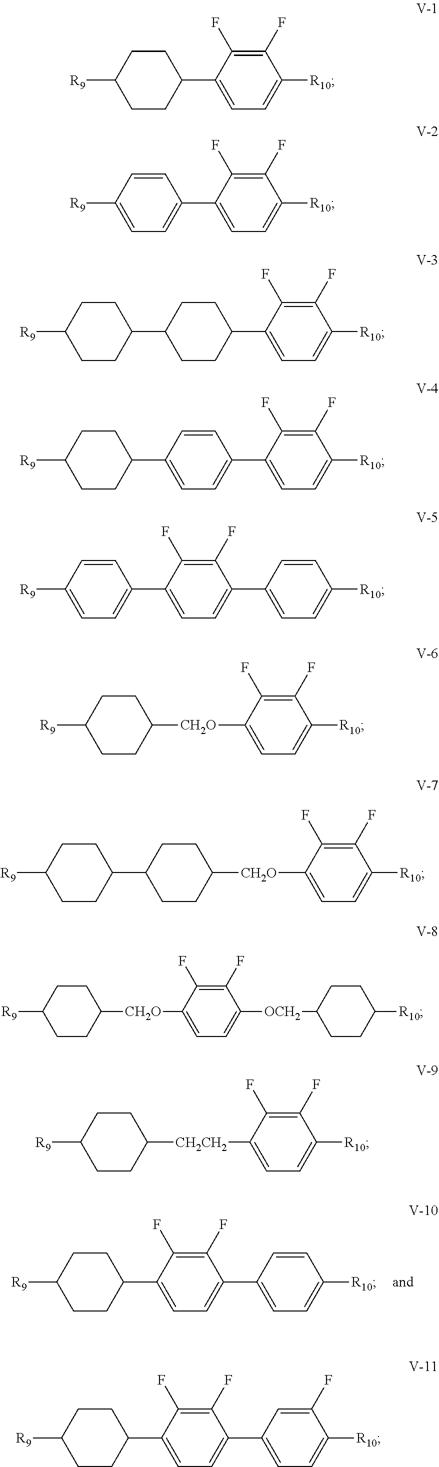

wherein R₉ and R₁₀ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₉ and R₁₀ may be each independently substituted with cyclopentyl, cyclobutyl or cyclopropyl.

Preferably, said liquid crystal composition is a dielectrically positive anisotropic liquid crystal composition, and further comprises one or more compounds represented by formula VI:

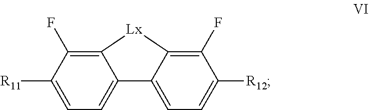

wherein R₁₁ and R₁₂ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₁₁ and R₁₂ may be each independently substituted with cyclopentyl, cyclobutyl or cyclopropyl; and

Lx represents CH₂, CH₂CH₂, O, S, CH₂O, OCH₂, CH₂S, SCH₂ or CF₂.

In the present invention, the compound represented by formula VI, with respect to the compound represented by formula V, has a larger vertical dielectric constant, and can further improve the transmittance of the liquid crystal composition; however, the rotary viscosity thereof is also larger than that of the compound of formula V, which may reduce the response speed of the liquid crystal composition.

Preferably, in said liquid crystal composition, the content in mass percentage of the compound as represented by structural formula VI is 1-15%, preferably 2-10%.

The liquid crystal compositions in different ratios of components will exhibit slightly different properties, such as a dielectric anisotropy Δε, an optical anisotropy Δn, a transition temperature point Cp when the nematic phase of the liquid crystal transforms into a liquid, stability at low temperatures, which all may be different, and can be used in different types of display devices, but have the same characteristic that the rotary viscosities γ₁ thereof are lower. The application to liquid crystal display devices can achieve a fast response.

Preferably, various functional dopants may be further added to the liquid crystal composition of the present invention; in said liquid crystal composition, the content of said dopants is preferably between 0.01% and 1% by mass.

Preferably, said dopants are one or more selected from an antioxidant, an ultraviolet absorber, and a chiral agent.

Preferably, said antioxidant is one or more selected from compounds represented by the following structural formulas:

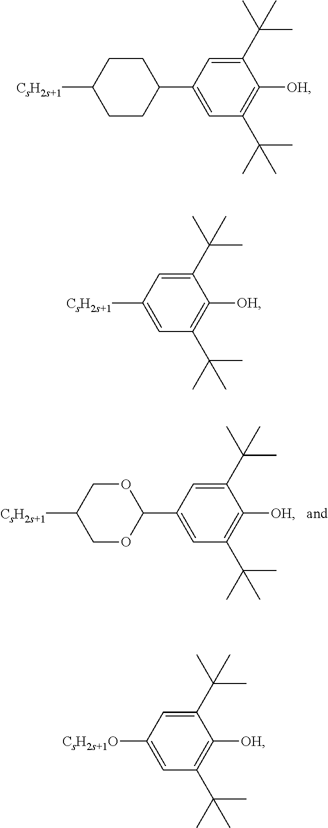

wherein S represents an integer of 1-10.

Preferably, said ultraviolet absorber is one or more selected from the compounds represented by the following structural formulas:

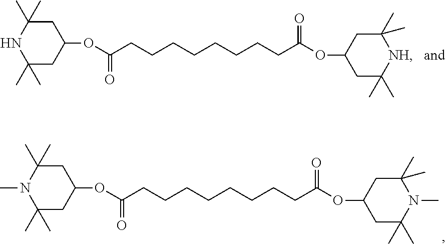

wherein S represents an integer of 1-10.

Preferably, said chiral agent is a left hand chiral agent or a right hand chiral agent; Furthermore, the structural formula of said chiral agent is one or more selected from compounds represented by the following structural formulas:

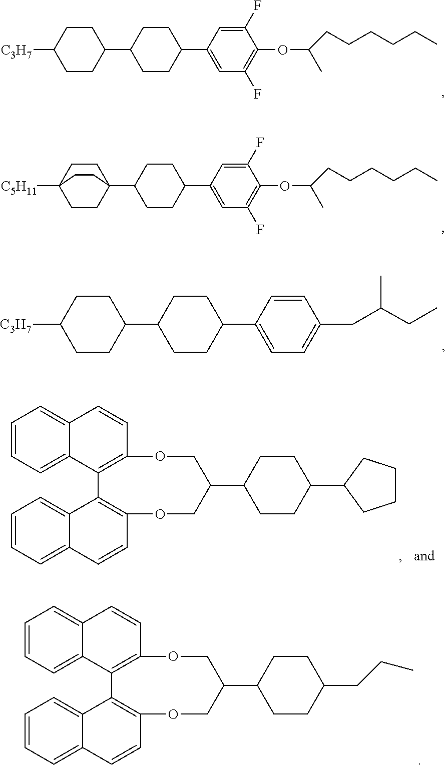

In order to achieve the above-mentioned second object, the following technical solution is used in the present invention:

a liquid crystal display component comprising the above-mentioned liquid crystal composition. It is to be understood that said liquid crystal display component includes liquid crystal display elements and liquid crystal display devices. The liquid crystal display element may be an active matrix addressing liquid crystal display element or a passive matrix display element; and the liquid crystal display device may be an active matrix addressing liquid crystal display or a passive matrix display.

Preferably, said active matrix addressing liquid crystal display element is a VA-TFT or IPS-TFT liquid crystal display element.

Preferably, said active matrix addressing liquid crystal display device is a VA-TFT or IPS-TFT liquid crystal display device.

The Present Invention has the Following Beneficial Effects:

The liquid crystal composition provided by the present invention has a lower viscosity, can achieve a fast response, and further has a moderate dielectric anisotropy Δε, a moderate optical anisotropy Δn, and a high stability to heat and light. The liquid crystal display component comprising the liquid crystal composition provided by the present invention has the characteristics of a broader nematic phase temperature range, a suitable birefringence anisotropy, a very high electrical resistivity, a good anti-ultraviolet property, a high charge retention ratio, and a fast response.

### DETAILED DESCRIPTION

In order to more clearly illustrate the present invention, the present invention will be further described below in conjunction with preferred embodiments. A person skilled in the art should understand that the following contents described in detail are illustrative rather than limiting, and should not limit the scope of protection of the present invention.

In the present invention, preparation methods are all conventional methods unless otherwise specified. The raw materials used are all available from open commercial approaches or prepared according to the prior art, unless otherwise specified, said percentages are all by mass unless otherwise specified, the temperatures are in degrees Celsius (° C.), and the specific meanings of the other symbols and the test conditions are as follows:

Cp represents the clearing point (° C.) of the liquid crystal measured by a DSC quantitative method;

S—N represents the melting point (° C.) of the liquid crystal from a crystal state to a nematic phase;

Δn represents the optical anisotropy, with Δn=nₑ−nₒ, in which nₒ is the refractive index of an ordinary light, nₑ is the refractive index of an extraordinary light, with the test conditions being: 25±2° C., 589 nm, and using an abbe refractometer for testing;

Δε represents the dielectric anisotropy, Δε=e_{//}−ε_{⊥}, wherein the ε_{//} is a dielectric constant parallel to a molecular axis, and ε_{⊥} is a dielectric constant perpendicular to the molecular axis, with the test conditions being: 25±0.5° C., 20-micron parallel cells, and INSTEC: ALCT-IR1 for testing;

γ1 represents a rotary viscosity (mPa·s), with the test conditions being: 25±0.5° C., 20-micron parallel cells, and INSTEC: ALCT-IR1 for testing; and

ρ represents an electrical resistivity (Ω·cm), with the test conditions being: 25±2° C., and the test instruments being a TOYO SR6517 high resistance instrument and an LE-21 liquid electrode.

VHR represents a voltage holding ratio (%), with the test conditions being: 20±2° C., a voltage of ±5 V, a pulse width of 10 ms, and a voltage holding time of 16.7 ms. The test equipment is a TOYO Model 6254 liquid crystal performance comprehensive tester.

τ represents a response time (ms), with the test instrument being DMS-501 and the test conditions being: 25±0.5° C., a test cell that is a 3.3-micron IPS test cell, an electrode spacing and an electrode width, both of which are 10 microns, and an included angle between the frictional direction and the electrode of 10°.

In the present invention, the equipment and instruments used for preparing the liquid crystal composition are:

(1) an electronic precision balance (with an accuracy of 0.1 mg)

(2) stainless steel beaker for weighing a liquid crystal monomer;

(3) a spoon for adding a liquid crystal monomer;

(4) a magnetic rotor for stirring; and

(5) a temperature-controlled electromagnetic stirrer.

A method for preparing a liquid crystal composition comprises the following steps:

(1) monomers to be used are placed in order neatly;

(2) a stainless steel beaker is placed on the balance, and the liquid crystal monomers are placed into the stainless steel beaker with small spoons;

(3) the monomer liquid crystals are added in order by weights as required;

(4) the stainless steel beaker, to which the materials have been added, is placed on a magnetic stirring instrument for heating and melting; and

(5) after the mixture in the stainless steel beaker is mostly melted, a magnetic rotor is added to the stainless steel beaker for uniformly stirring the liquid crystal mixture, and after cooling to room temperature, the liquid crystal composition is obtained.

In the embodiments of the present invention, liquid crystal monomer structures are represented by codes, wherein the codes of ring structures, end groups and linking groups of liquid crystals are represented, as shown in tables 1 and 2 below.

TABLE 1
Corresponding code for ring structure

| Ring structure | Corresponding code |
|---|---|
| 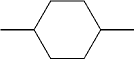 | C |
| 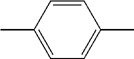 | P |
| 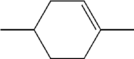 | L |
| 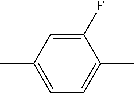 | G |
| 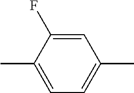 | Gi |
| 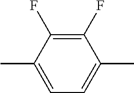 | Y |
| 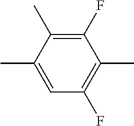 | K |
| 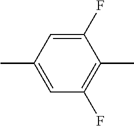 | U |
| 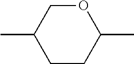 | A |
| 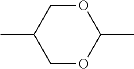 | D |
| 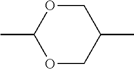 | Di |
| 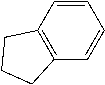 | Ida |
| 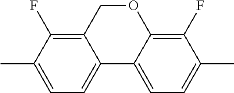 | Sa |
| 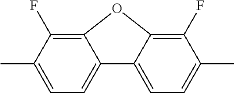 | Sb |
| 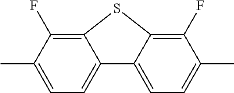 | Sc |
| 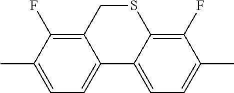 | Sd |

TABLE 2
Corresponding code for end group and linking group

| End group and linking group | Corresponding code |
|---|---|
| CₙH₂ₙ₊₁— | n- |
| CₙH₂ₙ₊₁O— | nO— |
| —OCF₃ | —OT |
| —CF₃ | —T |
| —CF₂O— | —Q— |
| —CH₂O— | —O— |
| —F | —F |
| —CN | —CN |
| —CH₂CH₂— | —E— |
| —CH═CH— | —V— |
| —COO— | —Z— |
| —CH═CH—CₙH₂ₙ₊₁ | Vn— |
| 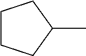 | Cp— |
| 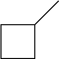 | Cb |
| 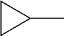 | Cpr— |
| 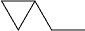 | Cpr1— |

### EXAMPLES

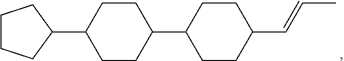 [SMILES: C/C=C/C1CCC(C2CCC(C3CCCC3)CC2)CC1 ; ","]

the code of which is CC-Cp-V1; and

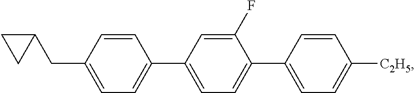 [SMILES: CCc1ccc(-c2ccc(-c3ccc(CC4CC4)cc3)cc2F)cc1]

the code of which is PGP-Cpr1-2.

The following specific embodiments are used to illustrate the present invention:

### Example 1

The formula of the liquid crystal composition and the corresponding properties thereof are as shown in table 3 below.

TABLE 3
Formula of the liquid crystal composition of Example 1 and the
corresponding properties thereof

| Classification | Liquid crystal monomer code | Content (%) |
|---|---|---|
| II | CC-3-2 | 30 |
| II | CC-3-V | 20 |
| I-2 | PGP-3-T | 2 |
| I-1 | PGP-3-OT | 3 |
| III | PPGi-5-F | 13 |
| III | PUQU-Cp-F | 17 |
| III | PGUQU-Cp-F | 6 |
| III | PPGU-Cp-F | 1 |
| III | CPGU-Cp-F | 3 |
| III | CPUP-3-OT | 5 |

| | |
|---|---|
| Performance | Δε [1 KHz, 20° C.]: 7.7; |
| parameter | ε_{⊥} [1 KHz, 20° C.]: 3.4 |
| | Δn [589 nm; 20° C.]: 0.12; |
| | Cp: 62° C.; |
| | γ₁: 52 mPa · s. |

Conclusion: the liquid crystal composition of Example 1 has a lower viscosity, can achieve a fast response, and further has a moderate dielectric anisotropy Δε, a moderate optical anisotropy Δn, and high stability to heat and light.

### Example 2

The formula of the liquid crystal composition and the corresponding properties thereof are as shown in table 4 below.

TABLE 4
Formula of the liquid crystal composition of Example 2 and the
corresponding properties thereof

| Classification | Liquid crystal monomer code | Content (%) |
|---|---|---|
| II | CC-3-2 | 25 |
| II | CC-3-V | 20 |
| I-1 | PGP-3-OT | 2 |
| I-1 | PGP-Cpr1-OT | 3 |
| III | PPGi-5-F | 13 |
| III | PUQU-Cp-F | 17 |
| III | PGUQU-Cp-F | 11 |
| III | PPGU-Cp-F | 1 |
| III | CPGU-Cp-F | 3 |
| III | CPUP-3-OT | 5 |

| | |
|---|---|
| Performance | Δε [1 KHz, 20° C.]: 9.2; |
| parameter | ε_{⊥} [1 KHz, 20° C.]: 3.5 |
| | Δn [589 nm, 20° C.]: 0.12; |
| | Cp: 65° C.; |
| | γ₁: 61 mPa · s. |

Conclusion: the liquid crystal composition of Example 2 has a lower viscosity, can achieve a fast response, and further has a moderate dielectric anisotropy Δε, a moderate optical anisotropy Δn, and high stability to heat and light.

### Example 3

The formula of the liquid crystal composition and the corresponding properties thereof are as shown in table 5 below.

TABLE 5
Formula of the liquid crystal composition of Example 3 and the
corresponding properties thereof

| Classification | Liquid crystal monomer code | Content (%) |
|---|---|---|
| II | CC-3-2 | 25 |
| II | CC-3-V | 20 |
| I-2 | PGP-3-T | 8 |
| I-2 | PGP-Cpr1-T | 12 |
| III | PPGi-5-F | 10 |
| III | PUQU-Cp-F | 10 |
| III | PGUQU-Cp-F | 6 |
| III | PPGU-Cp-F | 1 |
| III | CPGU-Cp-F | 3 |
| III | CPUP-3-OT | 5 |

| | |
|---|---|
| Performance | Δε [1 KHz, 20° C.]: 8.4; |
| parameter | ε_{⊥} [1 KHz, 20° C.]: 3.4 |
| | Δn [589 nm, 20° C.]: 0.13; |
| | Cp: 65° C.; |
| | γ₁: 55 mPa · s. |

Conclusion: the liquid crystal composition of Example 3 has a lower viscosity, can achieve a fast response, and further has a moderate dielectric anisotropy Δε, a moderate optical anisotropy Δn, and high stability to heat and light.

### Example 4

The formula of the liquid crystal composition and the corresponding properties thereof are as shown in table 6 below.

TABLE 6
Formula of the liquid crystal composition of Example 4 and the
corresponding properties thereof

| | | Content |
|---|---|---|
| Classification | Liquid crystal monomer code | (%) |
| II | CC-3-V | 10 |
| I-1 | PGP-3-OT | 6 |
| I-2 | PGP-2-T | 6 |
| II | PP-1-5 | 6 |
| II | CP-3-O2 | 4 |
| IV | CCP-3-2 | 11 |
| III | CCU-2-F | 12 |
| III | CCP-2-OT | 8 |
| III | PUQU-Cp-F | 17 |
| III | APUQU-Cp-F | 6 |
| III | CCPG-3-F | 5 |
| IV | CPP-2-3 | 9 |

| | |
|---|---|
| Performance | Δε[1 KHz, 20° C.]: 9.2; |
| parameter | ε_{⊥} [1 KHz, 20° C.]: 3.6 |
| | Δn [589 nm, 20° C.]: 0.13; |
| | Cp: 83° C.; |
| | γ₁: 84 mPa · s. |

### Comparative Example 1

The formula of the liquid crystal composition and the corresponding properties thereof are as shown in table 7 below.

TABLE 7
Formula of the liquid crystal composition of Comparative
Example 1 and the corresponding properties thereof

| Classification | Liquid crystal monomer code | Content (%) |
|---|---|---|
| II | CC-3-V | 10 |
| IV | PGP-3-5 | 6 |
| IV | PGP-2-3 | 6 |
| II | PP-1-5 | 6 |
| II | CP-3-O2 | 4 |
| IV | CCP-3-2 | 11 |
| III | CCU-2-F | 12 |
| III | CCP-2-OT | 8 |
| III | PUQU-Cp-F | 17 |
| III | APUQU-Cp-F | 6 |
| III | CCPG-3-F | 5 |
| IV | CPP-2-3 | 9 |

| | |
|---|---|
| Performance | Δε [1 KHz, 20° C.]: 7.8; |
| parameter | ε_{⊥} [1 KHz, 20° C.]: 3.5 |
| | Δn [589 nm, 20° C.]: 0.13; |
| | Cp: 80° C.; |
| | γ₁: 95 MPa · s. |

Conclusion: in contrast to Example 4, Comparative Example 1 relates to compounds of formulas IV with the structural formulas PGP-3-5 and PGP-2-3 instead of the compounds of structural formulas I-1 and I-2. Example 4 has a lower rotary viscosity γ₁, a higher clearing point Cp, and a higher dielectric anisotropy Δε, indicating that although the compounds of structural formulas PGP-3-5 and PGP-2-3 have a similar structure to the compounds of formulas I-1 and I-2, the compounds of formulas I-1 and I-2 have a lower rotary viscosity, a higher clearing point, and a higher dielectric anisotropy, such that Example 4 involving the compounds of formulas I-1 and I-2 has a lower drive voltage, a wider service temperature range, and a faster response speed.

### Example 5

The formula of the liquid crystal composition and the corresponding properties thereof are as shown in table 8 below.

TABLE 8
Formula of the liquid crystal composition of Example 5 and the
corresponding properties thereof

| Classification | Liquid crystal monomer code | Content (%) |
|---|---|---|
| II | CC-3-2 | 23 |
| II | CC-3-V1 | 12 |
| I-1 | PGP-Cp-OT | 8 |
| I-2 | PGP-4-T | 7 |
| III | CCU-2-F | 9 |
| III | CPU-3-F | 8 |
| IV | CCP-V2-1 | 10 |
| III | PGUQU-Cpr1-F | 17 |
| III | PGUQU-4-F | 6 |

| | |
|---|---|
| Performance | Δε [1 KHz, 20° C.]: 9.9; |
| parameter | ε_{⊥} [1 KHz, 20° C.]: 3.4 |
| | Δn [589 nm, 20° C.]: 0.12; |
| | Cp: 77° C.; |
| | γ₁: 88 mPa · s. |

### Comparative Example 2

The formula of the liquid crystal composition and the corresponding properties thereof are as shown in table 9 below.

TABLE 9
Formula of the liquid crystal composition of Comparative
Example 2 and the corresponding properties thereof

| Classification | Liquid crystal monomer code | Content (%) |
|---|---|---|
| II | CC-3-2 | 23 |
| II | CC-3-V1 | 12 |
| III | PGP-5-F | 8 |
| III | PGP-4-F | 7 |
| III | CCU-2-F | 9 |
| III | CPU-3-F | 8 |
| IV | CCP-V2-1 | 10 |
| III | PGUQU-Cpr1-F | 17 |
| III | PGUQU-4-F | 6 |

| | |
|---|---|
| Performance | Δε [1 KHz, 20° C.]: 8.9; |
| parameter | ε_{⊥} [1 KHz, 20° C.]: 3.4 |
| | Δn [589 nm, 20° C.]: 0.12; |
| | Cp: 82° C.; |
| | γ₁: 94 mPa · s. |

Conclusion: in contrast to Example 5, Comparative Example 2 relates to compounds of formulas III with the structural formulas PGP-4-F and PGP-5-F instead of the compounds of structural formulas I and I-2. Example 5 has a lower rotary viscosity γ₁ and a higher dielectric anisotropy Δε; in addition, Comparative Example 2 shows crystallization after storage for 100 hours in an environment of 0° C., whereas Example 5 does not show crystallization under the same conditions. This indicates that although the compounds of structural formulas PGP-4-F and PGP-5-F have a similar structure to the compounds of formulas I-1 and I-2, the compounds of formulas I-1 and I-2 have a lower rotary viscosity and a higher dielectric anisotropy; furthermore, cyclopentyl-substituted compounds of formula I-1 have a better intersolubility. Therefore, Example 5 comprising the compounds of formulas I-1 and I-2 have a lower drive voltage, a faster response speed, and a better low-temperature intersolubility.

### Example 6

The formula of the liquid crystal composition and the corresponding properties thereof are as shown in table 10 below.

TABLE 10
Formula of the liquid crystal composition of Example 6 and the
corresponding properties thereof

| Classification | Liquid crystal monomer code | Content (%) |
|---|---|---|
| II | CC-3-2 | 20 |
| II | CC-3-V | 18 |
| II | CP-3-O2 | 2 |
| I-1 | PGP-V2-OT | 5 |
| I-1 | PGP-Cpr1-OT | 5 |
| III | CCG-2-F | 12 |
| III | CCP-2-OT | 8 |
| III | PUQU-Cpr1-F | 17 |
| III | PGUQU-3-F | 8 |
| IV | CPPC-3-3 | 5 |

| | |
|---|---|
| Performance | Δε [1 KHz, 20° C.]: 7.9 |
| parameter | ε_{⊥} [1 KHz, 20° C.]: 3.6 |
| | Δn [589 nm, 20° C.]: 0.099; |
| | Cp: 64° C.; |
| | γ₁: 54 mPa · s. |

### Comparative Example 3

The formula of the liquid crystal composition and the corresponding properties thereof are as shown in table 11 below.

TABLE 11
Formula of the liquid crystal composition of Comparative
Example 3 and the corresponding properties thereof

| Classification | Liquid crystal monomer code | Content (%) |
|---|---|---|
| II | CC-3-2 | 20 |
| II | CC-3-V | 18 |
| II | CP-3-O2 | 2 |
| III | PGU-V2-F | 5 |
| III | PGU-4-F | 5 |
| III | CCG-2-F | 12 |
| III | CCP-2-OT | 8 |
| III | PUQU-Cpr1-F | 17 |
| III | PGUQU-3-F | 8 |
| IV | CPPC-3-3 | 5 |

| | |
|---|---|
| Performance | Δε [1 KHz, 20° C.]: 8.0; |
| parameter | ε_{⊥} [1 KHz, 20° C.]: 3.7 |
| | Δn [589 nm, 20° C.]: 0.098; |
| | Cp: 60° C.; |
| | γ₁: 58 mPa · s. |

Conclusion: in contrast to Example 6, Comparative Example 3 relates to compounds of formulas III with the structural formulas PGU-V2-F and PGU-4-F instead of the compound of structural formula I-1. Example 6 is comparable to Comparative Example 3 in terms of dielectric anisotropy, but has a higher optical anisotropy Δn, a higher clearing point Cp, and a lower rotary viscosity γ₁. The response speed of the liquid crystal display device is related to the thickness of the cell, and the smaller the thickness of the cell, the faster the response speed. Therefore, reducing the cell thickness of a liquid crystal display device is one of the methods for improving response speed. On the basis of the same delay amount design, for reducing the cell thickness of the liquid crystal display device, it is necessarily required to increase the optical anisotropy of the liquid crystal composition, so that Example 6 which has a higher optical anisotropy Δn is more suitable for the low cell thickness requirements of current fast response liquid crystal display devices.

### Example 7

The formula of the liquid crystal composition and the corresponding properties thereof are as shown in table 12 below.

TABLE 12
Formula of the liquid crystal composition of Example 7 and the
corresponding properties thereof

| Classification | Liquid crystal monomer code | Content (%) |
|---|---|---|
| II | CC-3-2 | 5 |
| II | CC-3-V | 45 |
| I-1 | PGP—Cp—OT | 5 |
| I-2 | PGP—Cpr—T | 5 |
| III | PPGi-5-F | 8 |
| III | PUQU—Cp—F | 10 |
| III | PGUQU-5-F | 6 |
| III | PPGU—Cp—F | 1 |
| V | CPY-3-O2 | 10 |
| III | CPUP-3-T | 5 |
| Additive | 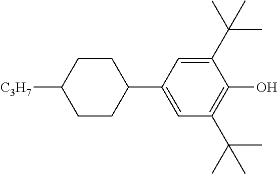 | 0.03 |
| Performance | Δε [1 KHz, 20° C.]: 6.0 | |
| parameter | ε_{⊥} [1 KHz, 20° C.]: 3.9 | |
| | Δn [589 nm, 20° C.]: 0.12 | |
| | Cp: 70° C. | |
| | γ₁: 59 mPa•s | |

Conclusion: The content of the additive in Example 7 is obtained by means of calculation based on the total content of the compounds as represented by formulas V, II, and V in the liquid crystal composition of Example 7 being 100%. Since the compound as represented by formula V has a larger vertical dielectric constant with respect to formula III, by adding a compound of formula V to the liquid crystal composition, the vertical dielectric constant of the liquid crystal composition can be increased, thereby improving the transmittance of the liquid crystal composition. Furthermore, by means of an antioxidant additive, the stability of the liquid crystal composition is improved.

### Example 8

The formula of the liquid crystal composition and the corresponding properties thereof are as shown in table 13 below.

TABLE 13
Formula of the liquid crystal composition of Example 8 and the
corresponding properties thereof

| Classification | Liquid crystal monomer code | Content (%) |
|---|---|---|
| II | CC-3-2 | 20 |
| II | CC-3-V | 18 |
| II | CP-3-O2 | 2 |
| I-1 | PGP-Cp-OT | 5 |
| I-1 | PGP-3-OT | 5 |
| III | CCU-3-F | 8 |
| III | CGU-2-F | 12 |
| III | PGU-2-F | 10 |
| III | PUQU-Cpr1-F | 10 |
| III | PGUQU-Cpr1-F | 3 |
| VI | Sb-Cp1O-O5 | 2 |
| VI | Sc-Cpr1O-O5 | 3 |
| VI | Sb-Cpr1O-O5 | 2 |

| | |
|---|---|
| Performance | Δε [1 KHz, 20° C.]: 7.5; |
| parameter | ε_{⊥} [1 KHz, 20° C.]: 4.8 |
| | Δn [589 nm, 20° C.]: 0.11; |
| | Cp: 42° C.; |
| | γ₁: 46 mPa · s. |

Conclusion: the compound represented by formula VI, with respect to the compound represented by formula V, has a larger vertical dielectric constant, and can further improve the transmittance of the liquid crystal composition; however, the rotary viscosity thereof is also larger than that of the compound of formula V; if same is used too much, the response speed of the liquid crystal composition may be reduced.

### Example 9

The formula of the liquid crystal composition and the corresponding properties thereof are as shown in table 14 below.

TABLE 14
Formula of the liquid crystal composition of Example 9 and the
corresponding properties thereof

| Classification | Liquid crystal monomer code | Content (%) |
|---|---|---|
| II | CC-3-2 | 10 |
| I-1 | PGP-1V2-OT | 6 |
| I-2 | PGP-V2-T | 6 |
| II | PP-1-5 | 8 |
| II | CP-3-O2 | 6 |
| IV | CCG-3-2 | 11 |
| III | CPU-3-F | 8 |
| III | CPU-2-F | 12 |
| III | DCU-3-F | 10 |
| V | CY-3-O2 | 10 |
| V | CCY-4-O2 | 5 |
| III | PUQU-Cpr1-F | 5 |
| III | PGUQU-Cpr1-F | 3 |

| | |
|---|---|
| Performance | Δε [1 KHz, 20° C.]: 8.0; |
| parameter | ε_{⊥} [1 KHz, 20° C.]: 5.0 |
| | Δn [589 nm, 20° C.]: 0.13; |
| | Cp: 58° C.; |
| | γ₁: 87 mPa · s. |

### Example 10

The formula of the liquid crystal composition and the corresponding properties thereof are as shown in table 15 below.

TABLE 15
Formula of the liquid crystal composition of Example 10 and the
corresponding properties thereof

| Classification | Liquid crystal monomer code | Content (%) |
|---|---|---|
| II | CC-3-2 | 23 |
| II | CC-3-V1 | 12 |
| I-2 | PGP-3Cp-T | 7 |
| I-2 | PGP-Cpr1-T | 8 |
| IV | CPP-2-2 | 9 |
| IV | CPP-3-2 | 5 |
| III | PUQK-5-F | 9 |
| III | PGUQK-3-F- | 5 |
| III | PUQU-Cpr1-F | 10 |
| III | PGUQU-Cpr1-F | 7 |
| VI | Sb-Cp1O-O5 | 3 |
| VI | Sc-Cpr1O-O5 | 2 |

| | |
|---|---|
| Performance | Δε [1 KHz, 20° C.]: 9.0; |
| parameter | ε_{⊥} [1 KHz, 20° C.]: 4.5 |
| | Δn [589 nm, 20° C.]: 0.13; |
| | Cp: 63° C.; |
| | γ₁: 72 mPa · s. |

### Example 11

The formula of the liquid crystal composition and the corresponding properties thereof are as shown in table 16 below.

TABLE 16
Formula of the liquid crystal composition of Example 11 and the
corresponding properties thereof

| Classification | Liquid crystal monomer code | Content (%) |
|---|---|---|
| II | CC-3-2 | 20 |
| II | CC-3-V | 20 |
| I-1 | PGP-3-OT | 2 |
| I-1 | PGP-5-OT | 3 |
| III | IdaUQU-3-F | 8 |
| III | IdaGUQU-5-F | 10 |
| III | PGP-3-F | 8 |
| III | PGP-5-F | 7 |
| V | CY-3-O2 | 5 |
| V | PY-3-O2 | 5 |
| V | COY-3-O1 | 5 |
| V | CCOY-3-O2 | 5 |
| VI | Sb-Cp1O-O5 | 2 |

| | |
|---|---|
| Performance | Δε [1 KHz, 20° C.]: 4.5; |
| parameter | ε_{⊥} [1 KHz, 20° C.]: 5.6 |
| | Δn [589 nm, 20° C.]: 0.12; |
| | Cp: 61° C.; |
| | γ₁: 64 mPa · s. |

### Example 12

The formula of the liquid crystal composition and the corresponding properties thereof are as shown in table 17 below.

TABLE 17
Formula of the liquid crystal composition of Example 12 and the
corresponding properties thereof

| Classification | Liquid crystal monomer code | Content (%) |
|---|---|---|
| II | CC-3-2 | 20 |
| II | CC-3-V | 20 |
| I-1 | PGP-Cpr1-OT | 3 |
| I-2 | PGP-Cpr1-T | 2 |
| III | PUQK-5-F | 4 |
| III | PGUQK-3-F | 4 |
| III | DUQK-5-F | 4 |
| III | CPUQK-3-F | 4 |
| III | APUQK-3-F | 4 |
| III | PUQU-Cp-F | 4 |
| III | PUQU-Cpr1-F | 4 |
| III | PGUQU-Cp-F | 4 |
| III | PGUQU-Cpr1-F | 4 |
| III | PPGU-3-F | 2 |
| IV | CCP-V2-1 | 6 |
| IV | CCP-V-1 | 4 |
| V | CPY-3-O2 | 3 |
| V | PY-3-02 | 2 |
| VI | Sb-Cp1O-O5 | |

| | |
|---|---|
| Performance | Δε [1 KHz, 20° C.]: 9.6; |
| parameter | ε_{⊥} [1 KHz, 20° C.]: 4.5 |
| | Δn [589 nm, 20° C.]: 0.11; |
| | Cp: 64° C.; |
| | γ₁: 67 mPa · s. |

Conclusion: As can be seen from the above examples, the liquid crystal compositions provided by the examples of the present invention have a lower rotary viscosity γ₁, is used for liquid crystal display, can achieve a fast response, and further has a moderate dielectric anisotropy Δε, a moderate optical anisotropy Δn, and a high stability to heat. They are especially suitable for liquid crystal materials for TN, IPS, and VA modes.

Obviously, the above-mentioned embodiments of the present invention are merely examples for clearly illustrating the present invention, rather than limiting the embodiments of the present invention; for a person of ordinary skill in the art, on the basis of the above description, other variations or changes in different forms may also be made, all the embodiments cannot be provided exhaustively herein, and any obvious variation or change derived from the technical solution of the present invention is still within the scope of protection of the present invention.

1. A liquid crystal composition, characterized in that said liquid crystal composition comprises one or more compounds as represented by structural formula I-1 and/or one or more compounds as represented by structural formula I-2, one or more compounds as represented by structural formula II, and one or more compounds as represented by structural formula III: 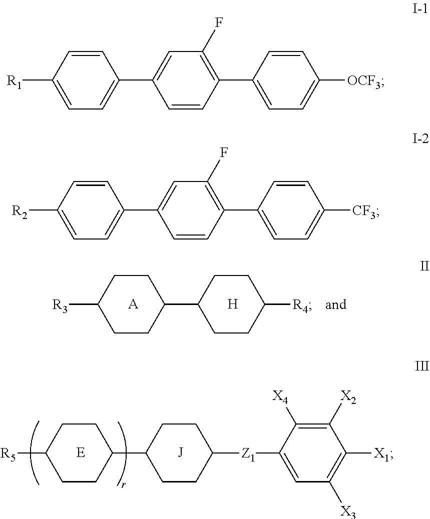
wherein
R₁, R₂, R₃ and R₅ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more non-connected CH₂ in the groups represented by R₁, R₂, R₃ and R₅ may be each independently substituted with cyclopentyl, cyclobutyl, cyclopropyl or oxygen;
R₄ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more non-connected CH₂ in the groups represented by R₄ may be substituted with cyclopentyl, cyclobutyl or cyclopropyl;
Z₁ represents a single bond, —CH₂CH₂—, —CH₂O—, or —CF₂O—; 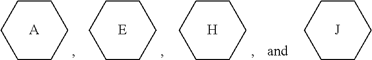
each independently represent 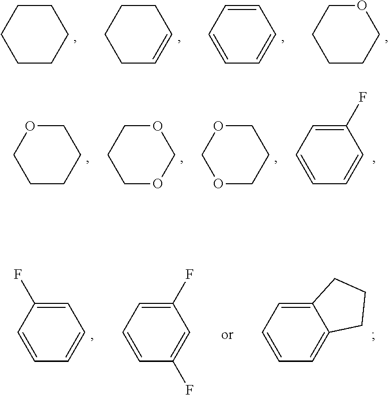
X₁ represents F, fluoroalkyl, fluoroalkoxy, fluoroalkenyl or fluoroalkenyloxy;
X₂, X₃ and X₄ each independently represent H, F, fluoroalkyl, fluoroalkoxy, fluoroalkenyl, fluoroalkenyloxy, or methyl;
r represents 0, 1 or 2; and where r represents 1, Z₁ represents a single bond, X₂, X₃ and X₄ all represent H, 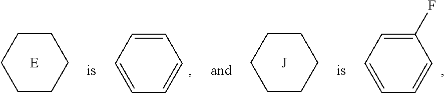
X₁ cannot be OCF₃ or CF₃.

2. The liquid crystal composition according to claim 1, characterized in that said liquid crystal composition further comprises one or more compounds represented by formula IV, 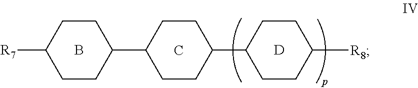
wherein R₇ and R₈ represent an alkyl group having a carbon atom number of 1-10, an alkoxy group having a carbon atom number of 1-10, an alkenyl group having a carbon atom number of 2-10 or an alkenoxy group having a carbon atom number of 3-8, wherein any one or more CH₂ in the groups represented by R₇ and R₈ may be each independently substituted with cyclopentyl, cyclobutyl or cyclopropyl; 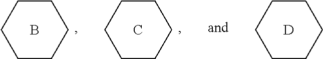
each independently represent 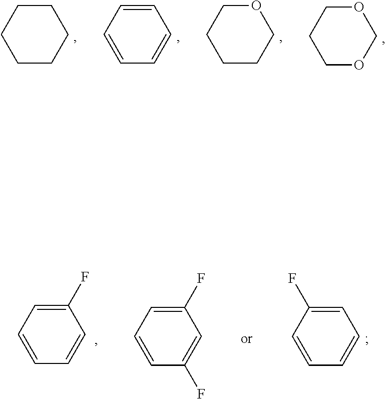
and P represents 1 or 2.

3. The liquid crystal composition according to claim 1, characterized in that said liquid crystal composition further comprises one or more compounds represented by formula V: 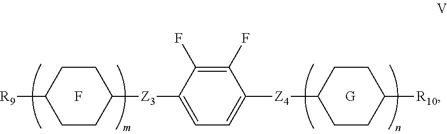
wherein R₉ and R₁₀ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₉ and R₁₀ may be each independently substituted with cyclopentyl, cyclobutyl or cyclopropyl;
Z₃ and Z₄ each independently represent a single bond, —CH₂CH₂— or —CH₂O—; 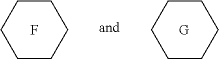
each independently represent 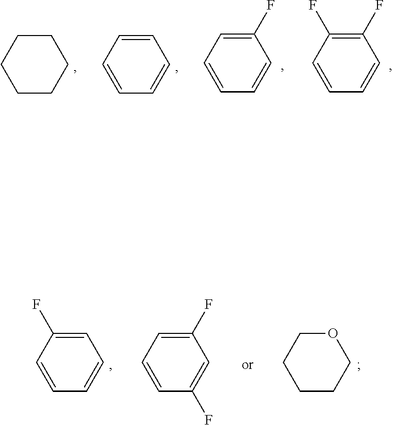
m represents 1 or 2; and n represents 0, 1 or 2.

4. The liquid crystal composition according to claim 1, characterized in that said liquid crystal composition further comprises one or more compounds represented by formula VI: 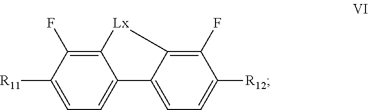
wherein R₁₁ and R₁₂ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₁₁ and R₁₂ may be each independently substituted with cyclopentyl, cyclobutyl or cyclopropyl; and
Lx represents CH₂, CH₂CH₂, O, S, CH₂O, OCH₂, CH₂S, SCH₂ or CF₂.

5. The liquid crystal composition according to claim 1, characterized in that the structural formula of the compounds as represented by structural formula II is specifically one or more selected from formulas II-1 to II-13 below: 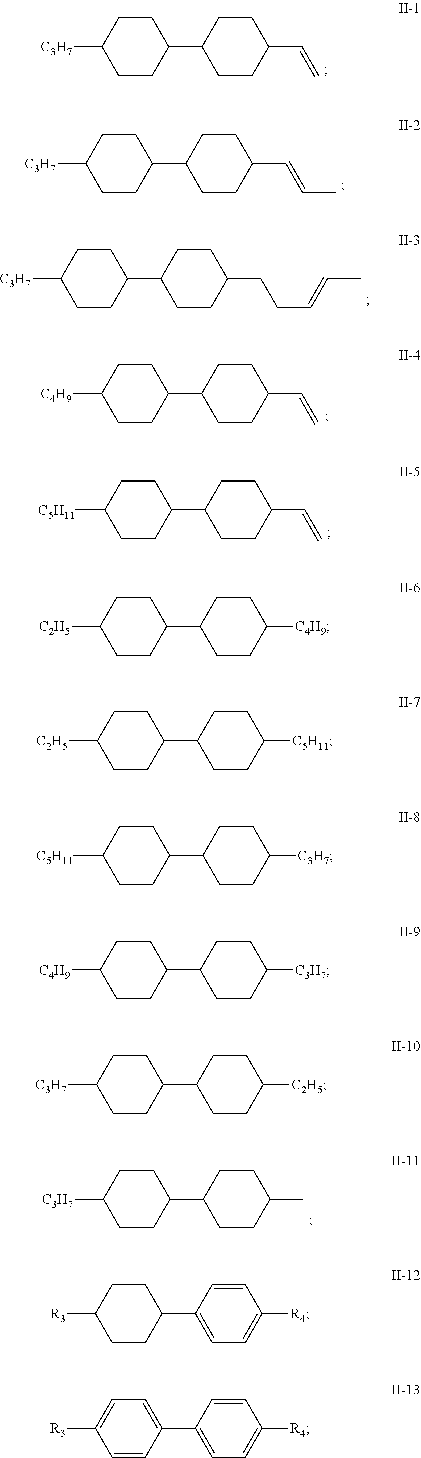
wherein
R₃ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more non-connected CH₂ in the groups represented by R₃ may be substituted with cyclopentyl, cyclobutyl, cyclopropyl or oxygen; and
R₄ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more non-connected CH₂ in the groups represented by R₄ may be substituted with cyclopentyl, cyclobutyl or cyclopropyl.

6. The liquid crystal composition according to claim 1, characterized in that the structural formula of the compounds as represented by structural formula III is specifically one or more selected from formulas III-1 to III-47 below: 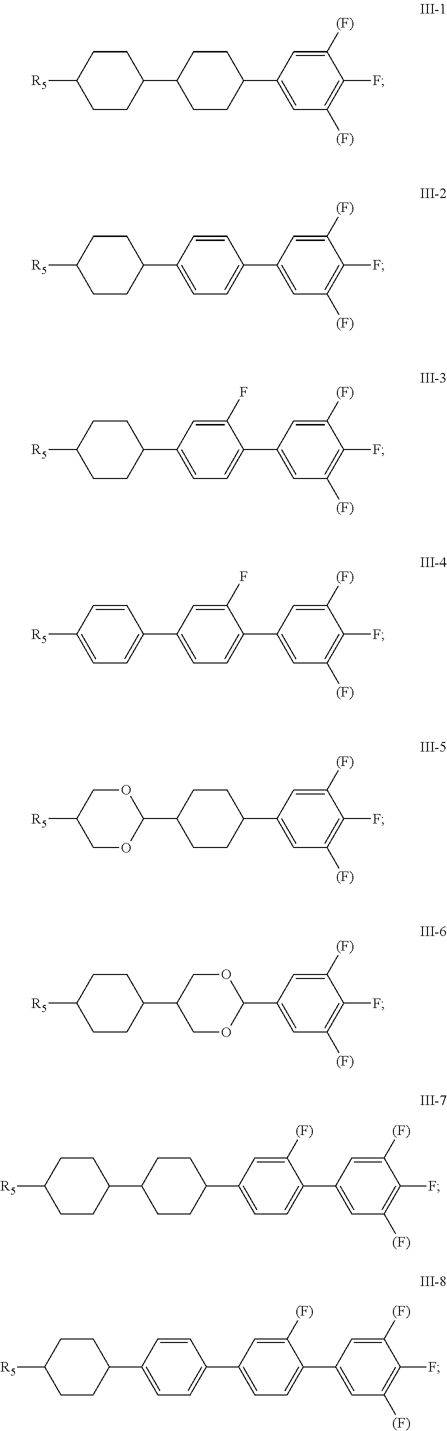 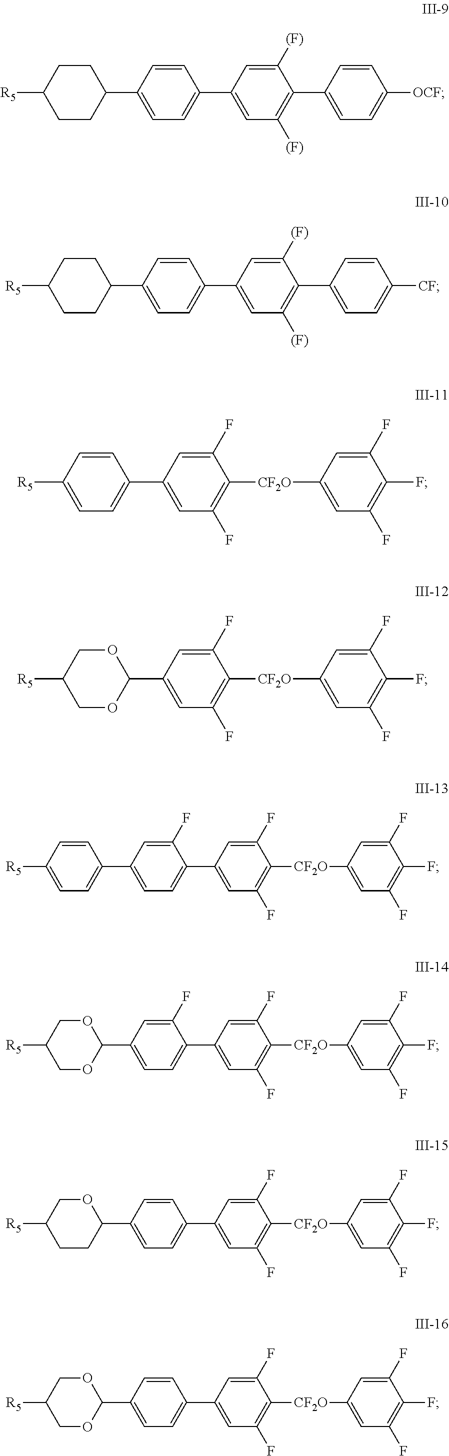 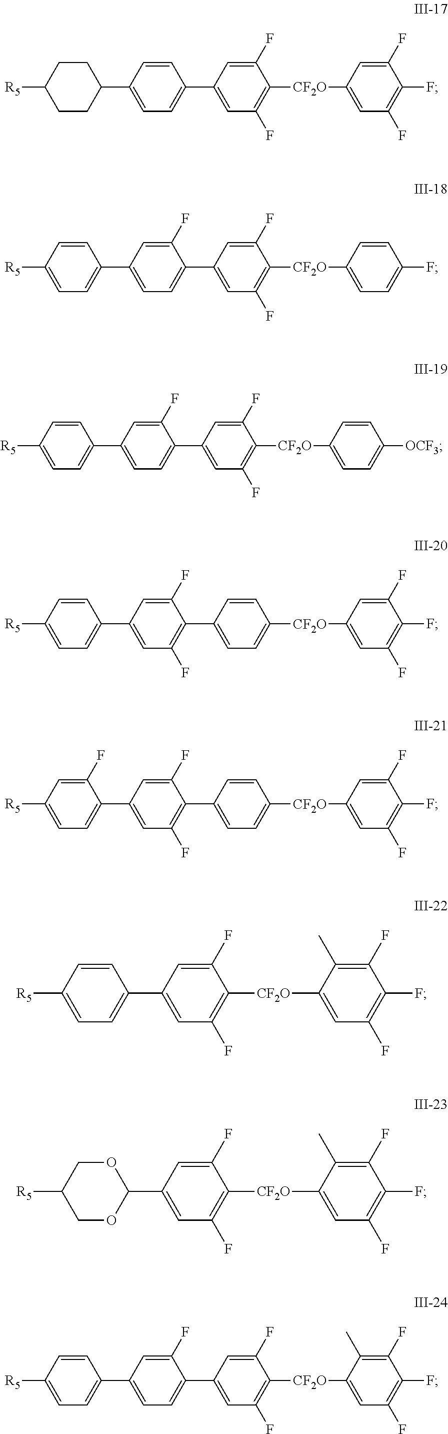 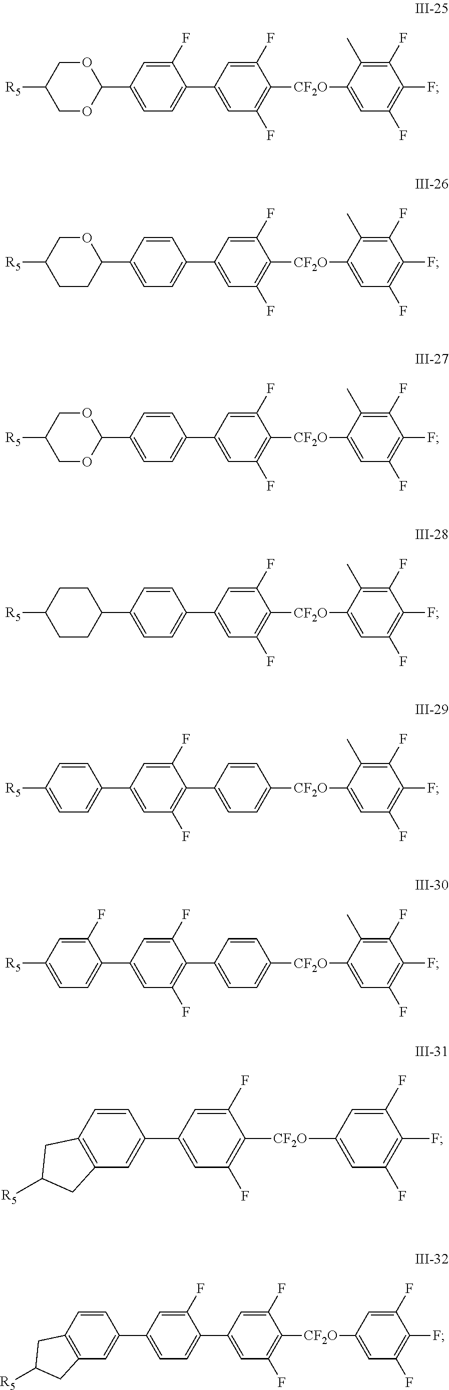 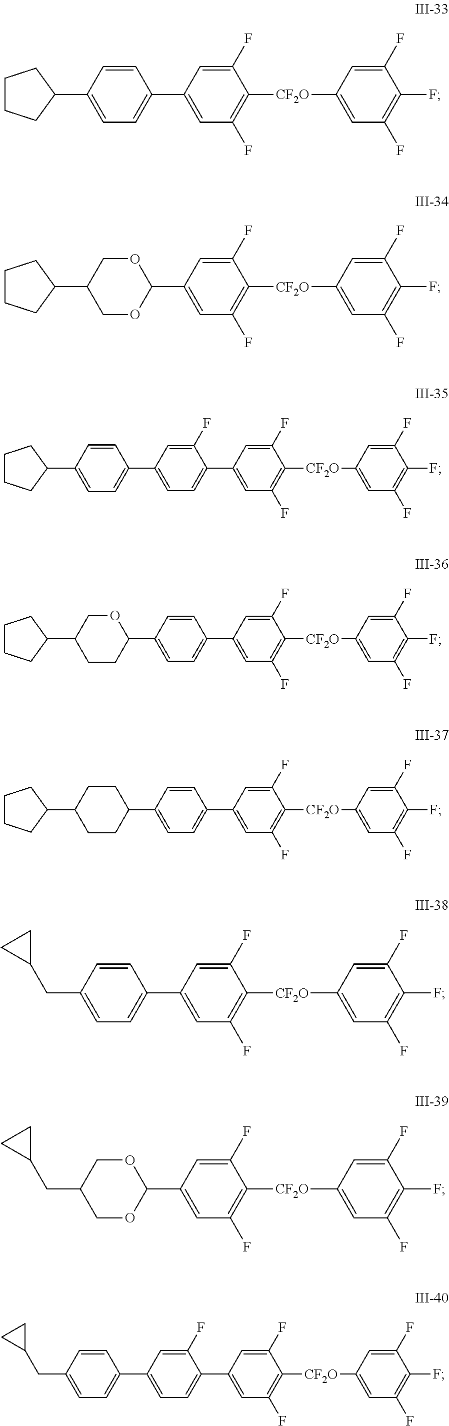 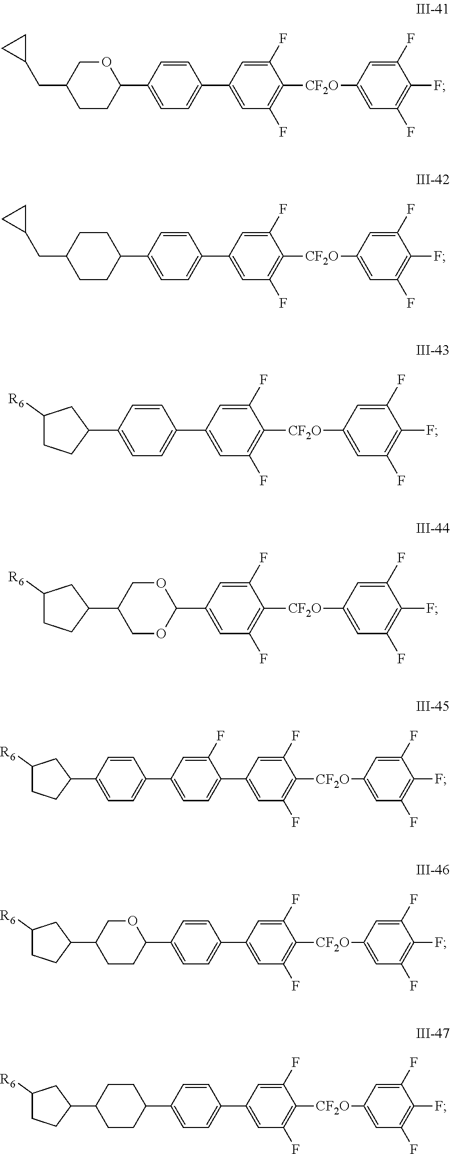
wherein R₅ and R₆ each independently represent an alkyl group having a carbon atom number of 1-5, a fluoro-substituted alkyl group having a carbon atom number of 1-5, an alkoxy group having a carbon atom number of 1-5, a fluoro-substituted alkoxy group having a carbon atom number of 1-5, an alkenyl group having a carbon atom number of 2-5, a fluoro-substituted alkenyl group having a carbon atom number of 2-5, an alkenoxy group having a carbon atom number of 3-5 or an fluoro-substituted alkenoxy group having a carbon atom number of 3-5; and
(F) represents F or H.

7. The liquid crystal composition according to claim 2, characterized in that the structural formula of the compound as represented by structural formula IV is specifically one selected from formulas IV-1 to IV-6 below: 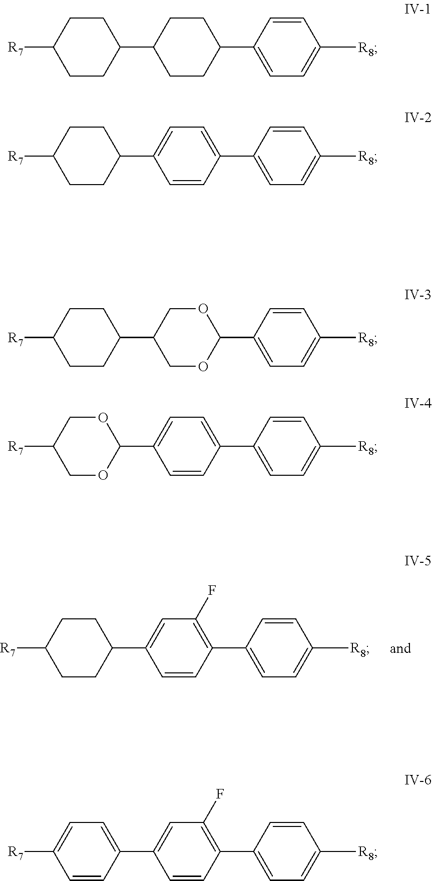
wherein R₇ and R₈ represent an alkyl group having a carbon atom number of 1-5, an alkoxy group having a carbon atom number of 1-5, an alkenyl group having a carbon atom number of 2-5, or an alkenoxy group having a carbon atom number of 3-8, wherein any one or more CH₂ in the groups represented by R₇ and R₈ may be each independently substituted with cyclopentyl, cyclobutyl or cyclopropyl.

8. The liquid crystal composition according to claim 3, characterized in that the structural formula of the compound as represented by structural formula V is specifically one selected from formulas V-1 to V-11 below: 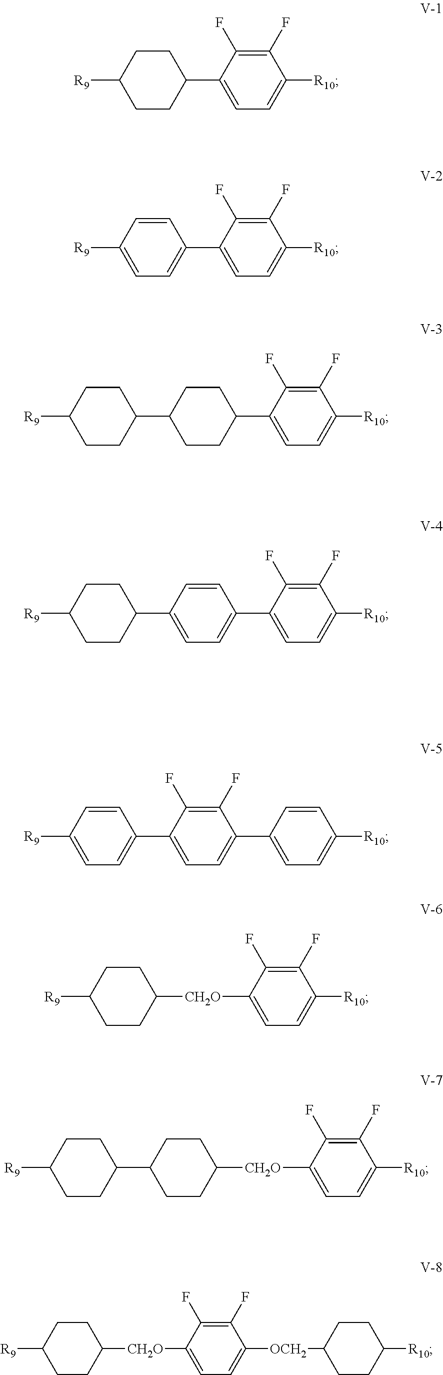 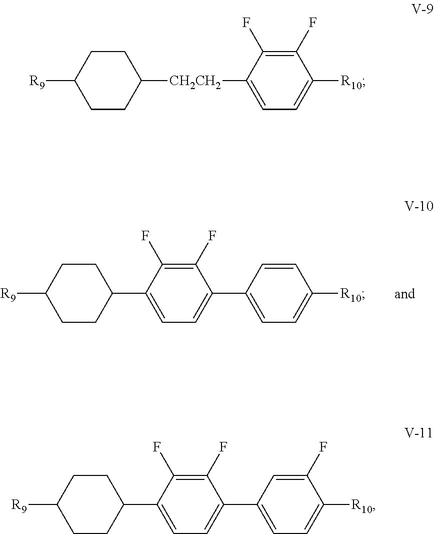
wherein R₉ and R₁₀ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₉ and R₁₀ may be each independently substituted with cyclopentyl, cyclobutyl or cyclopropyl.

9. A liquid crystal display component, characterized in that said liquid crystal display component comprising the liquid crystal composition according to claim 1.

10. The liquid crystal composition according to claim 2, characterized in that said liquid crystal composition further comprises one or more compounds represented by formula V: 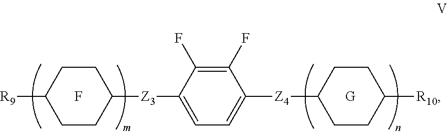
wherein R₉ and R₁₀ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₉ and R₁₀ may be each independently substituted with cyclopentyl, cyclobutyl or cyclopropyl;
Z₃ and Z₄ each independently represent a single bond, —CH₂CH₂— or —CH₂O—; 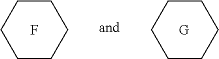
each independently represent 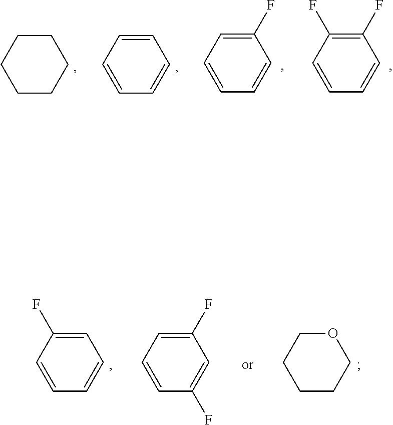
m represents 1 or 2; and n represents 0, 1 or 2.

11. The liquid crystal composition according to claim 2, characterized in that said liquid crystal composition further comprises one or more compounds represented by formula VI: 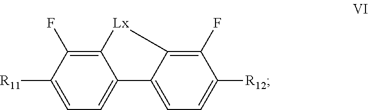
wherein R₁₁ and R₁₂ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₁₁ and R₁₂ may be each independently substituted with cyclopentyl, cyclobutyl or cyclopropyl; and
Lx represents CH₂, CH₂CH₂, O, S, CH₂O, OCH₂, CH₂S, SCH₂ or CF₂.

12. The liquid crystal composition according to claim 3, characterized in that said liquid crystal composition further comprises one or more compounds represented by formula VI: 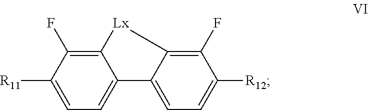
wherein R₁₁ and R₁₂ each independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8, wherein any one or more CH₂ in the groups represented by R₁₁ and R₁₂ may be each independently substituted with cyclopentyl, cyclobutyl or cyclopropyl; and
Lx represents CH₂, CH₂CH₂, O, S, CH₂O, OCH₂, CH₂S, SCH₂ or CF₂.
